(19) United States
(12) Patent Application Publication
(10) Pub. No.: US 2008/0129646 A1
(43) Pub. Date: Jun. 5, 2008

(54) MULTI-FUNCTION PICTURE FRAME

(76) Inventor: Dilip Bhavnani, Beverly Hills, CA (US)

Correspondence Address: THE SONI LAW FIRM, 55 S. LAKE AVE SUITE 720, PASADENA, CA, 91101, US

(21) Appl. No.: 11/566,162

(22) Filed: Dec. 1, 2006

(51) Int. Cl. G09G 5/00; A47G 1/06

(52) U.S. Cl. 345/1.1; 40/725

(57) ABSTRACT

A multi-function desktop photo frame configured to interchangeably display graphic images in either a conventional paper format or digital format, and incorporating some of widely used office functions. In the preferred embodiment, the photo frame includes an AM/FM radio and an LCD screen on which an alphanumeric message, inputted by a user via a message input unit, scrolls for effectively reminding the user of important messages. Further, the photo frame may include other common office electronics such as a digital clock and/or a thermometer.

### FIELD OF THE INVENTION

The present invention relates to field of a multi-function desktop picture frame, incorporating a scrolling message displayer, an AM/FM radio, and other utilities such as a digital clock and/or a thermometer.

### CROSS-REFERENCE TO RELATED APPLICATION

(Not Applicable)

### STATEMENT RE: FEDERALLY SPONSORED RESEARCH/DEVELOPMENT

(Not Applicable)

### BACKGROUND OF THE INVENTION

Desktop picture frames are widely used as almost an essential desktop accessories in business offices, houses, or other living spaces for displaying memorable photos, family photos, or other favorite pictures. They also form an important part of decoration in those places.

Owing to the development of technology, picture frames nowadays are capable of retaining and displaying pictures or photos not only in the conventional paper format, but in the digital format as well. The advantage in using such digital pictures is that a digital picture frame can store and selectively display multiple digital pictures without having to print them out.

Besides picture frames, other desktop utilities such as a digital alarm clock, a thermometer, an FM/AM radio, and a message board are also commonly used in various office settings. Therefore, if a picture frame can be integrated with those utilities, it would provide for a user not only the convenience of using several office functions at will from a single multi-function frame, but also the advantage of saving desktop spaces, and thereby, permitting larger desktop working space. Further, a neat integration of such office utilities would help enhance the aesthetics of office work environment.

A couple of prior art disclose combining a photo frame with some of the basic office desktop utilities. U.S. Patent Application Publication No. 2005/0057578 A1, teaches a digital photo frame incorporating a digital alarm clock and a radio where the time information and radio channel information is displayed on a LCD panel formed at the border of the frame. This reference, however, fails to teach combining the clock and radio functions to a conventional photo frame displaying paper-format graphics, and further, utilizing the frame as a message board capable of attracting a user's attention and reminding of important messages, such as a scrolling text message displayer. U.S. Pat. No. 6,266,069 teaches a picture frame that can display a picture in both the paper and digital format on a main display, and sequently display loop of digital images on several LCD displays formed at the border of the frame. The picture frame in the reference, however, fails to disclose incorporation of a digital clock and a radio, and further, the use of a scrolling text message displayer for a message reminder.

Therefore, it would be desirable to provide a multi-function frame that combines a photo frame, displaying either a conventional paper-format graphic or digital images, with a digital alarm clock and a FM/AM radio. It would be further desirable to incorporate into such a frame, the function of a message board that can retain and keep reminding a user of an important messages via, for instance, a scrolling message displayer. Moreover, it would be desirable if such desktop multi-function frame can provide, with all the utilities aforementioned, a neat and compact appearance as well, and even some space thereon to place advertising materials for advertisement.

### SUMMARY OF THE INVENTION

The present invention provides a multi-function desktop photo frame that may display, in one embodiment, a conventional paper-form pictures, and in another, digital graphics. The present invention also incorporates into the photo frame an AM/FM radio, a scrolling message displayer together with message input means in order to keep reminding a user of important messages, and other common electronics like a digital clock and/or a thermometer.

More specifically, the multi-function photo frame made in accordance with the present invention is largely comprised of a substantially planar photo frame that is configured to interchangeably retain and display, in one embodiment a conventional paper-based graphics, and in another, digital images stored in a removable memory device on a LCD screen.

The photo frame also comprises an AM/FM radio with a speaker and tuning means and a scrolling message displayer with a means for inputting alphanumeric messages, acting as a digital message board. The character message may be scrollingly displayed on a LCD screen formed at the boundary of the photo frame to attract the user's attention more effectively.

In the preferred embodiment, the photo frame may further comprise at least one digital signal generator, such as a digital alarm clock and/or a digital thermometer, that generates a digital signal consisting of characters and numbers, whereby the digital signal is displayed on the LCD screen alternately with the scrolling messages. In the case of a digital photo frame, such digital signals may be displayed on the main LCD screen for displaying digital images.

One of the advantages of the present invention is to provide for a user convenience of using several office functions at ease by structurally and functionally integrating them into a single multi-function frame. Other advantages of such integration of desktop utilities is saving of desktop spaces, larger desktop working spaces available, and consequentially, enhancement in work efficiency. Anther advantage is, owing to the neat and compact appearance of the multi-function frame, enhancing aesthetics of office working environment. Further, through the scrolling message displayer, a user can easily and conveniently store important messages and be effectively reminded of them.

Lastly, the present invention provides an effective means for advertising and promotion. Since the multi-function photo frame would be accessed and used more frequently by a user and more likely to attract attentions of other viewers owing to its neatly integrated multiple utilities, it can be an effective vehicle for advertisement as well, whereby advertising materials can be permanently imprinted on any outer surface thereof.

### BRIEF DESCRIPTION OF THE DRAWINGS

FIG. 1 is a perspective view of the multi-function photo frame made in the preferred embodiment of the present invention, displaying a conventional paper-format graphics;

FIG. 2 is a front elevational view of the multi-function photo frame made in the preferred embodiment of the present invention;

FIG. 3 is a side elevational view of the multi-function photo frame made in the preferred embodiment of the present invention;

FIG. 4 is a side elevational view, opposite to the side shown in FIG. 3, of the multi-function photo frame made in the preferred embodiment of the present invention; and

FIG. 5 is a rear elevational view of the multi-function photo frame made in the preferred embodiment of the present invention.

### DETAILED DESCRIPTION OF THE INVENTION

The present invention generally relates to a multi-function desktop photo frame displaying graphic images either in a physical or in digital format and carrying other office desktop accessories. More particularly, the photo frame incorporates a digital alarm clock, a thermometer, an AM/FM radio, and a scrolling message displayer to keep reminding a user of important messages.

Several preferred embodiments of the present invention will now be described with reference to FIGS. (‘FIGS.’) 1-5, wherein like components are designated by like reference numerals throughout the figures. Although the present invention is generally described in terms of the preferred embodiments, it should be understood that it is shown and described, only by way of illustration of the best mode contemplated in carrying out the invention, but not intended to limit in any way the spirit and scope of the invention to the particular embodiments described.

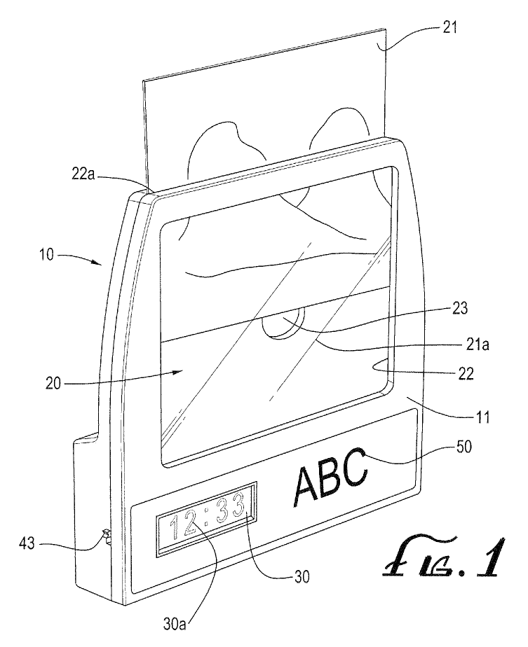

Now referring to FIG. 1, the multi-function desktop photo frame made in the preferred embodiment of the present invention comprises largely a frame 10 having a front frame side 11 and an opposing rear frame side 12. The frame 10 comprises a generally planar upper frame section to be used as a photo frame 20 and a contiguous lower planar frame section which has a bigger thickness, and thus, a wider bottom surface to help the frame 10 stand thereon in a substantially upright position, and to define a compartment (not shown) to encase therein electronic circuitry of several electronic devices to be described below. For a further support to the upright position, the frame 10 may further comprise a generally half-pyramid shaped support member 13 integrally formed on the rear frame side 12 in the preferred embodiment as shown in FIGS. 1, 3, and 4. The frame 10 has a generally rectangular or square shape as shown in FIGS. 1-5, but may have any other geometrical shape without departing the spirit of the present invention. The frame 10 can be fabricated of any proper material, including but not limited to, wood, metal, plastics, cardboard, polymeric compositions, fiberglass, hardboard, or any other rigid or semi rigid material.

In the preferred embodiment, a photo frame 20 is formed on the front frame side 11 in the upper frame section, with means for interchangeably retaining and selectively displaying at least one photo, picture, or any other graphic image, either in the conventional format where the graphic image is borne on a thin and substantially planar article such as a piece of paper, or in a digital format.

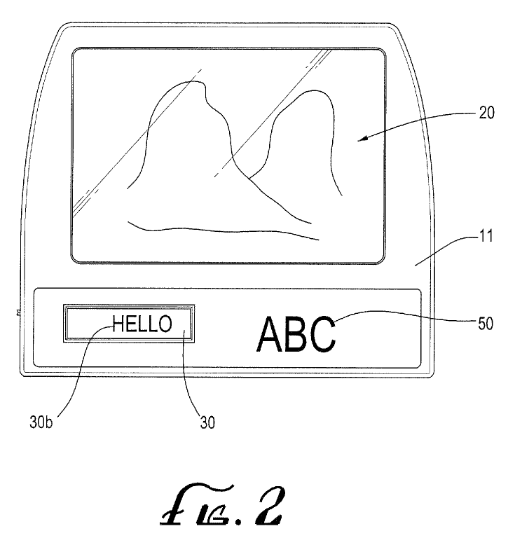

In the preferred embodiment described in FIGS. 1 and 2, the graphic image takes the form of a traditional paper imprints 21 and the aforementioned means may comprise, a compartment (not shown) formed in the upper frame for retaining the graphic image therein. Part of the compartment is exposed to the front frame side 11 to define a recessed window 22 through which the paper imprint 21 is displayed. The paper imprint 21 may be inserted into or taken out of the compartment for interchange with others through a slot 22a defined at an edge of the frame 10 as shown in FIG. 2. To help the removal of the paper imprint 21 from the compartment, a finger opening 23 may be defined on the rear frame side 12 as shown in FIGS. 2 and 5 through which a user can push the paper imprint 21 upward with a finger and easily take it out of the compartment. In another embodiment (not shown), the paper imprint 21 may be directly and removably fitted into the recessed window via grooves, instead of the slot 22a in FIG. 2, defined along the side edges thereof. In still another embodiment, the paper imprint 21 may be removably retained directly on the front frame side 11 by a variety of attachment means commonly used in a photo frame, such as pins, clips, clamps, adhesives, scotch tapes, or double-sided tapes.

In the preferred embodiment, the size of the recessed window 22 is, though not necessarily limited so, big enough to retain a photo having dimensions of at least 3 and ½ inches by 5 inches, the size of commonly used photos. The size of the frame 10 would be accordingly determined. Further, the recessed window 22 may be covered by a transparent cover 21a detachably or removably disposed on top of the paper imprint 21 for its protection.

In another embodiment (not shown), the graphic images may be in a digital format. In that embodiment, an electric circuitry for reading and selectively displaying a plurality of digital images is encased either in the upper or lower frame section. The plurality of digital images may be stored in re-writable memory device such as the commonly used portable flash memory drive, which may be removably Fitted into a memory slot defined at an edge of the frame. To display such digital images, a display screen, Such as an LCD screen, is formed on the front frame side, preferably in the upper frame section. Such electric circuitry, display screen, and memory device are well known in the art, and thus, not described herein further. The power for the electric circuit and the display screen may be supplied from a conventional AA batteries contained in a compartment formed in the frame. Furthermore, to turn on or off power and browse and select among the plurality of digital images, a control unit such as typical push buttons may be formed on the frame, preferably next to the display screen.

Moreover, the multi-function photo frame in the present invention comprises a scrolling message displayer whereby a message inputted by a user repeatedly scrolls across a display screen to keep the user being reminded of the contents of the message. The circuitry for reading and scrolling the inputted message is typical and well known to those skilled in the art, and therefore, not described herein further. The circuitry is encased, preferably, in the lower frame section, and to scrollingly display an inputted message, a display screen 30, preferably an LCD screen, is formed preferably on the front frame side 11 below the photo frame 20 as depicted in FIGS. 1 and 2.

The input message is alphanumeric and typically consists of characters for names, words, or other contents and numbers for appointment time and date, for instance, and a few special characters. To input a selected message, the multi-function photo frame further comprises a message input means which is formed on an outer surface of the frame 10 and electrically connected to the circuitry. In the preferred embodiment, the message input means comprise a typical press buttons 31 formed on the rear frame side 12 as shown in FIG. 5. The way of inputting a preselected message using such buttons is commonly used in various devices displaying time information, such as a digital watch, an audio player, a TV, or a video tape recorder/player, for setting present time by pressing a couple of attached press buttons. For example, the buttons 31 may be marked respectively as ‘SET’, ‘UP’, and ‘DOWN’ as in the preferred embodiment. Each time when a user presses the ‘SET’ button, the display screen 30 successively displays previously inputted numeric values for hour, minute, day, and month, which can be changed to new values by pressing the ‘UP’ and ‘DOWN’ buttons as necessary which, at each press, increase or decrease the numeric values by one. After finishing inputting all numeric values for appointment time, for instance, the user can input word messages, such as the name of the appointee, by repeatedly pressing the ‘SET’ button, while, between each press of the ‘SET’ button, inputting alphanumeric characters composing the messages with the ‘UP’ and ‘DOWN’ buttons. The circuitry needed for such an input method is well known to the one skilled in the art, and thus, not described further.

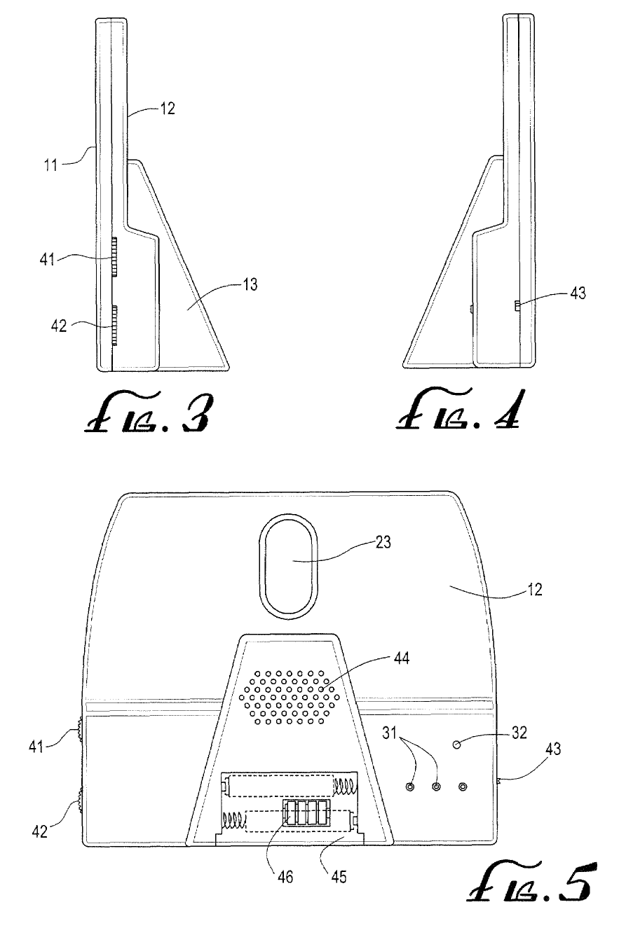

The multi-function photo frame comprises, in the preferred embodiment, an AM/FM radio. The radio circuitry encased, preferably, in the lower frame section, is typical and well known in the art, and thus, not described herein further. The speaker 44 is located, in the preferred embodiment, in the supporting member 13 as shown in FIG. 5, but may be in any other part of the frame 10. For controlling the radio circuitry, a tuning dial 41, a power and volume control dial 42, and a FM/AM selection switch 43 are formed on a side surface of the frame 10 in the preferred embodiment as shown in FIGS. 3 and 4. But they may be formed on any outer surface of the frame 10. In one embodiment, the radio channel information may be displayed on the display screen 30 as well, alternately with the scrolling messages and digital signals, but in another, it may not.

To supply power to the circuitry of the AM/FM radio, the scrolling message displayer, the LCD, and the signal generators such as the digital clock and/or the thermometer, the frame 10 may further comprise a radio battery compartment 45 containing AA batteries, formed preferably in the supporting member 13 below the radio speaker 44 as shown in FIG. 5. But the radio battery compartment 45 may be located elsewhere on the frame 10, either on the front or rear frame side.

In the preferred embodiment, the multi-function photo frame may further comprise at least one digital signal generators, such as a digital alarm clock, or a thermometer, whose circuitry is encased also, preferably, in the lower frame section of the frame 10. The typical circuitry of each is also well known in the art, and therefore, not described herein further. The digital signals generated therefrom, such as time information from the digital clock and/or the current temperature from the thermometer, may be displayed, separately or together, on the LCD screen 30 as the scrolling inputted message. In the preferred embodiment, the circuitry is configured to alternately display the scrolling inputted message and the digital signals at a predetermined time interval. When the inputted message is displayed on the LCD screen 30, it may be made scroll always, in one embodiment, regardless of the length of the message, and in another, only when the message is so long that the entire message cannot be fitted into the screen at one time. To hear the alarming sound from the digital alarm clock, a small alarm speaker 32 may be formed on the rear frame surface 12 as seen in FIG. 5. Further, the power for the digital signal generators may be separately supplied from cell batteries contained in a separate compartment 46 formed behind the radio battery compartment 45 as shown in FIG. 5.

The present invention provides an effective means for advertising and promotion. Since the multi-function photo frame would be more likely to attract attentions of the user and other observers owing to its neatly integrated multiple utilities as well as the scrolling messages, it can be an effective vehicle for advertisement as well. FIGS. 1 and 2 show that advertising materials 50 imprinted on the front frame side 11, preferably below the photo frame 20. But the advertising material may be imprinted on any outer surface of the frame 10.

The present invention is capable of embodiments other than those described above, and its several details are capable of modifications in various respects apparent to those of ordinary skill in the art, all without departing from the essential spirit or attributes of the invention. Therefore, the embodiments described hereinbefore should be considered to be merely illustrative, not restrictive.

What is claimed is:

1. A multi-function frame comprising:
a frame having opposing front and rear frame sides, the front frame side defining a display area thereon;
a graphic displaying means for interchangeably retaining and displaying a graphical image on the display area;
a display screen formed on the front frame side;
at least one input unit formed on said frame for inputting data;
a digital signal generator encased within said frame and electrically connected to the display screen for generating at least one digital signal and outputting the at least one digital signal thereto; and
an electric unit encased within said frame and electrically connected to both the at least one input unit and the display screen, the electric unit being configured to receive the data from the input unit and to translate the data into an alphanumeric message for displaying on the display screen.

2. The multi-function frame as in claim 1 wherein the digital signal and the alphanumeric message are alternately displayed on the display screen at a preset time interval.

3. The multi-function frame as in claim 1, wherein the electric unit is configured to scroll the alphanumeric message across the display screen.

4. The multi-function frame as in claim 3, wherein said digital signal generator includes a digital alarm clock and the at least one digital signal includes time data.

5. The multi-function frame as in claim 4, wherein said digital signal generator further includes a digital thermometer and the at least one digital signal includes temperature data.

6. The multi-function frame as in claim 1 further comprising a radio, a speaker electrically connected to the radio, and a radio control unit electrically connected to both the radio and the speaker, the radio control unit being configured to tune radio channels, to selectably power the radio, and adjust volume outputted to the speaker.

7. The multi-function frame as in claim 6, wherein the radio is electrically connected to the display screen for outputting radio information thereto.

8. The multi-function frame as in claim 1 wherein the frame further comprises a supporting member formed on the rear frame side thereof for maintaining the frame in a substantially upright position when placed on a horizontal surface.

9. The multi-function frame as in claim 1, wherein the display area is configured to display a graphic having an area of at least 17.5 square inches.

10. The multi-function frame as in claim 9, wherein said display area is configured to receive at least one thin substantially planar article bearing a graphical image.

11. The multi-function frame as in claim 10, wherein said display area comprises a transparent cover removably disposed upon the least one thin substantially planar article.

12. The multi-function frame as in claim 9, wherein said graphic displaying means is configured for interchangeably retaining and selectively displaying a plurality of digital graphics.

13. The multi-function frame as in claim 12, wherein said graphic displaying means comprises:
a) a slot defined on said frame for removably receiving an external memory device containing the plurality of digital graphics;
b) a digital screen formed on the display area for displaying the plurality of digital graphics thereon;
c) an electric circuitry encased in the frame for reading and selectively displaying the plurality of digital graphics on said screen;
d) a power unit encased in said frame for supplying power to said electric circuit and said screen; and
e) a graphic control unit disposed on said frame for turning on or off power and selecting among the plurality of digital graphics.

14. The multi-function frame as in claim 1, further comprising advertising material imprinted on at least one outer surface thereof.

15. A multi-function frame comprising:
a frame having opposing front and rear frame sides, the front frame side defining a display area thereon;
a graphic displaying means for interchangeably retaining and displaying at least one thin and substantially planar article bearing a graphical image on the display area;
a display screen formed on the front frame side;
at least one input unit formed on said frame for inputting data;
a digital signal generator encased within said frame and electrically connected to the display screen for generating at least one digital signal and outputting the at least one digital signal thereto; and
an electric unit encased within said frame and electrically connected to both the at least one input unit and the display screen, the electric unit being configured to receive the data from the input unit and to translate the data into an alphanumeric message for displaying on the display screen.

16. The multi-function frame as in claim 15 wherein the digital signal and the alphanumeric message are alternately displayed on the display screen at a preset time interval.

17. The multi-function frame as in claim 15, wherein the electric unit is configured to scroll the alphanumeric message across the display screen.

18. The multi-function frame as in claim 17, wherein said digital signal generator includes a digital alarm clock and the at least one digital signal includes time data.

19. The multi-function frame as in claim 18, wherein said digital signal generator further includes a digital thermometer and the at least one digital signal includes temperature data.

20. The multi-function frame as in claim 15 further comprising a radio, a speaker electrically connected to the radio, and a radio control unit electrically connected to both the radio and the speaker, the radio control unit being configured to tune radio channels, to selectably power the radio, and adjust volume outputted to the speaker.

21. The multi-function frame as in claim 20, wherein the radio is electrically connected to the display screen for outputting radio information thereto.

22. The multi-function frame as in claim 15 wherein the frame further comprises a supporting member formed on the rear frame side thereof for maintaining the frame in a substantially upright position when placed on a horizontal surface.

23. The multi-function frame as in claim 15, wherein the display area is configured to display a graphic having an area of at least 17.5 square inches.

24. The multi-function frame as in claim 15, further comprising advertising material imprinted on at least one outer surface thereof.

25. A method of advertising comprising the steps of:
(a) providing a multi-function frame comprising:
a frame having opposing front and rear frame sides, the front frame side defining a display area thereon;
a graphic displaying means for interchangeably retaining and displaying a graphical image on the display area;
a display screen formed on the front frame side;
at least one input unit formed on said frame for inputting data;
a digital signal generator encased within said frame and electrically connected to the display screen for generating at least one digital signal and outputting the at least one digital signal thereto; and
an electric unit encased within said frame and electrically connected to both the at least one input unit and the display screen, the electric unit being configured to receive the data from the input unit and to translate the data into an alphanumeric message for displaying on the display screen.
(b) disposing advertising material on a visible outer surface of the multi-function frame.
